(19) United States
(12) Patent Application Publication
(10) Pub. No.: US 2026/0161490 A1
(43) Pub. Date: Jun. 11, 2026

(54) METHOD, APPARATUS, DEVICE AND STORAGE MEDIUM FOR CREATING WORKFLOW

(71) Applicant: Beijing Zitiao Network Technology Co., Ltd., Beijing (CN)

(72) Inventors: Ren ZHOU, Beijing (CN); Shunliang QIANG, Beijing (CN)

(21) Appl. No.: 19/182,024

(22) Filed: Apr. 17, 2025

(30) Foreign Application Priority Data
Dec. 10, 2024 (CN) 202411814907.1

(51) Int. Cl. G06F 9/54

(52) U.S. Cl. CPC G06F 9/546

(57) ABSTRACT

Embodiments of the disclosure relate to a method, a device, an apparatus and a storage medium for creating a workflow. An example method provided herein includes: adding, in response to a received edit operation, a session processing node to a node connection graph; acquiring configuration information for the session processing node, the configuration information at least indicating a first session identifier of a first session corresponding to the session processing node; and creating a target workflow based on the node connection graph.

### CROSS-REFERENCE

The present application claims priority to Chinese Patent Application No. 202411814907.1, filed on Dec. 10, 2024 and entitled “METHOD, APPARATUS, DEVICE AND STORAGE MEDIUM FOR CREATING WORKFLOW”, the entirety of which is incorporated herein by reference.

### FIELD

Example embodiments of the present disclosure generally relate to the field of computers, and in particular, to a method, a device, and a computer-readable storage media for creating a workflow.

### BACKGROUND

With the development of computer technologies, people can create various types of applications through some platforms. In a process of application development, creating and managing workflows is an important task. For example, users can edit nodes in a workflow to indicate a requested processing flow.

### SUMMARY

In a first aspect of the present disclosure, a method for creating a workflow is provided. The method includes: adding, in response to a received edit operation, a session processing node to a node connection graph; acquiring configuration information for the session processing node, the configuration information at least indicating a first session identifier of a first session corresponding to the session processing node; and creating a target workflow based on the node connection graph.

In a second aspect of the present disclosure, an apparatus for creating a workflow is provided. The apparatus includes: an adding module configured to add a session processing node to a node connection graph in response to a received edit operation; a configuration module configured to acquire configuration information for the session processing node, the configuration information at least indicating a first session identifier of a first session corresponding to the session processing node; and a creating module configured to create a target workflow based on the node connection graph.

In a third aspect of the present disclosure, an electronic device is provided. The electronic device includes: at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has stored thereon a computer program executable by a processor to implement the method of the first aspect.

It should be understood that the content described in this summary section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure can be implemented;

FIGS. 2A to 2F illustrate example interfaces according to some embodiments of the present disclosure;

FIG. 3 illustrates a flowchart of an example process of creating a workflow according to some embodiments of the present disclosure;

FIG. 4 illustrates a schematic structural block diagram of an example apparatus for creating a workflow according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout this document and any type of embodiments may be included in any section/subsection. Furthermore, embodiments described in any section/subsection may be combined in any manner with any other embodiment described in the same section/subsection and/or different sections/subsections.

In the description of the embodiments of the present disclosure, the terms “including” and the like should be understood as open-ended inclusion, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data collection, acquisition, processing, transmission, and usage are performed on the premise that the user knows and confirms. Accordingly, when implementing the various embodiments of the present disclosure, the types of data or information involved, the scope of use, the usage scenarios, etc., shall be communicated to the user and authorized by the user in accordance with relevant laws and regulations through appropriate means. The specific methods of notification and/or authorization may vary depending on actual circumstances and application scenarios, and the scope of the present disclosure is not limited in this regard.

In the solutions in the present specification and the embodiments, if personal information processing is involved, such processing shall be conducted under a legal basis (e.g., obtaining consent from the personal information subject or as necessary for the performance of a contract, etc.) and only within the prescribed or agreed scope. A user's refusal to process personal information beyond what is necessary for basic functionalities will not affect their use of the basic functionalities.

Some workflows support user interaction with created applications through a conversational approach, such as intelligent agents, bots, and the like. Traditionally, such applications typically correspond to a single session, and developers of the applications are unable to effectively manage sessions within the applications.

Embodiments of the present disclosure provide a solution for creating a workflow. The solution includes: in response to a received edit operation, adding a session processing node to a node connection graph; obtaining configuration information of the session processing node, wherein the configuration information at least indicates a first session identifier of a first session corresponding to the session processing node; and creating a target workflow based on the node connection graph.

In this way, embodiments of the present disclosure can support managing a session related to a workflow in a node manner, thereby improving efficiency of session management.

Various example implementations of this scheme are described in detail below in conjunction with the accompanying drawings.

### Example Environment

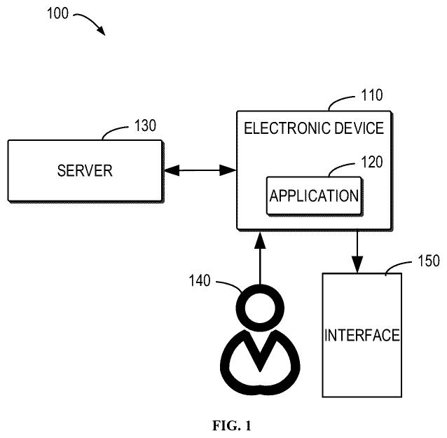

FIG. 1 illustrates a schematic diagram of an example environment 100 in which embodiments of the present disclosure can be implemented. As shown in FIG. 1, the example environment 100 may include an electronic device 110.

In the example environment 100, an application 120 that supports interface interaction may run on the electronic device 110. The application 120 may be any suitable type of application for interface interaction, examples of which may include, but are not limited to, development applications or other suitable applications. A user 140 may interact with the application 120 via the electronic device 110 and/or its attached device.

In the environment 100 of FIG. 1, if the application 120 is in an active state, the electronic device 110 may present, via the application 120, an interface 150 for supporting workflow creation.

In some embodiments, the electronic device 110 communicates with a server 130 to enable provision of services for the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 in the electronic device 110 that supports virtual scenes.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for illustrative purposes only and do not imply any limitation to the scope of the present disclosure.

Some example embodiments of the present disclosure will be further described below with reference to the accompanying drawings.

### Example Interaction

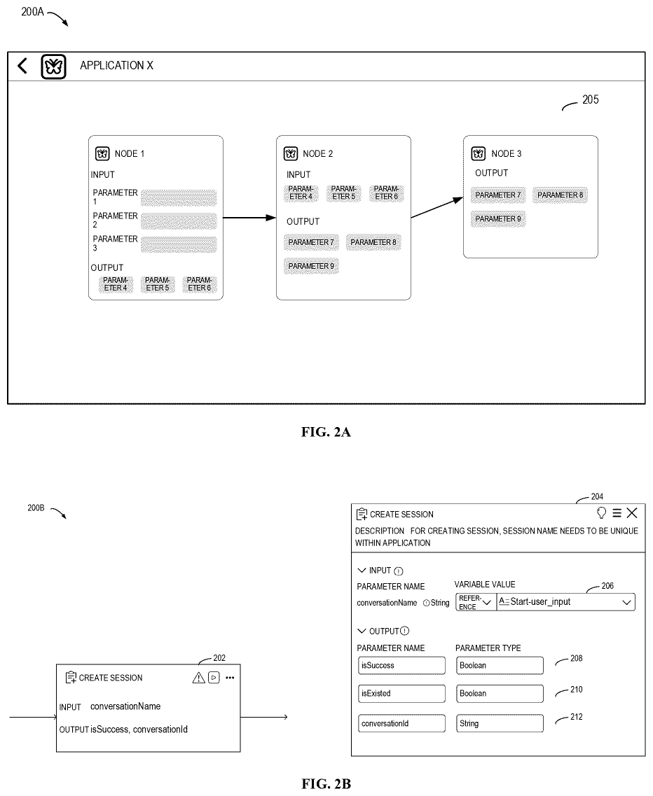

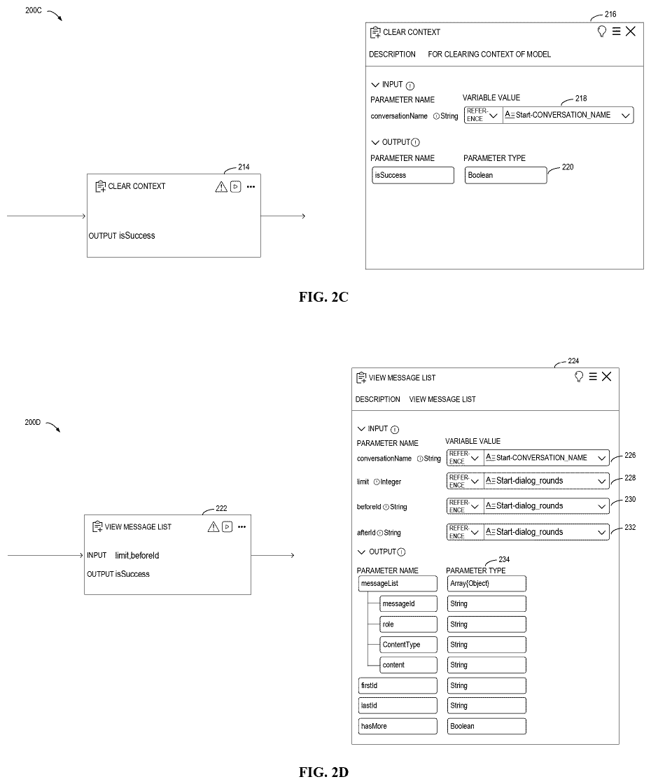

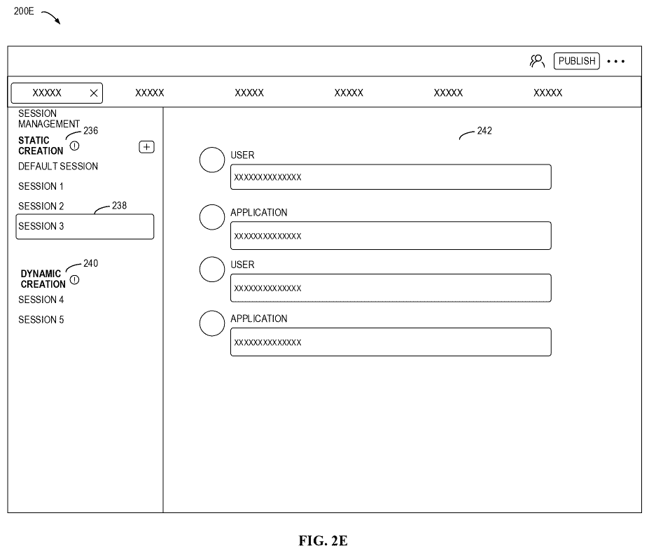

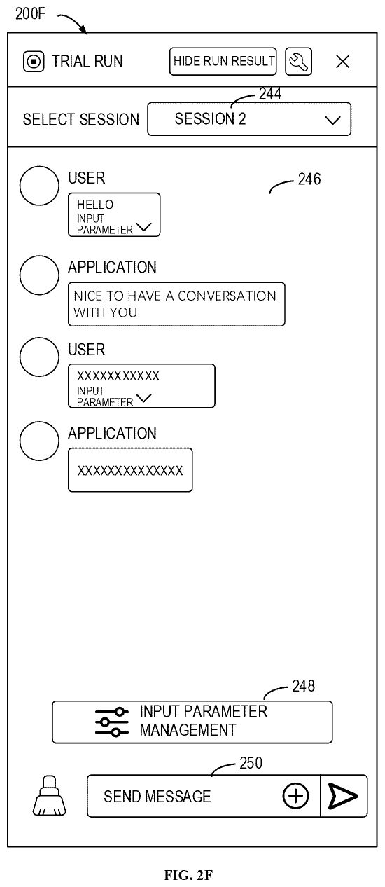

An example interaction of creating a workflow according to some embodiments of the present disclosure will be described below in conjunction with FIGS. 2A-2F. FIGS. 2A-2F illustrate example interfaces 200A-200F according to some embodiments of the present disclosure. The interfaces 200A-200F may be provided, for example, by the electronic device 110 shown in FIG. 1.

As shown in FIG. 2A, the interface 200A may correspond to an edit interface of a workflow 205. As an example, the edit interface 200A may include a canvas component for editing a node connection graph corresponding to the workflow 205.

In some embodiments, the interface 200A may also be associated with an application to be created. As an example, the application may be associated with one or more workflows, and the interface 200A may correspond to an edit interface for the workflow 205 associated with the application.

As shown in FIG. 2A, in the interface 200A, the electronic device 110 may support various types of node edit operations by the user, such as adding nodes in the canvas component, deleting nodes, connecting nodes, modifying node properties, and the like.

In some embodiments, the electronic device 110 may support adding a session processing node (also referred to as a session managing node) to the node connection graph in the canvas component for managing sessions associated with the workflow or the application.

In some embodiments, the electronic device 110 may, for example, provide one or more preconfigured types of session processing nodes in the interface 200A, and may support the user in adding a corresponding session processing node in the canvas component by dragging and dropping nodes or through other suitable interactions.

In some embodiments, the session processing node may include a session creating node. FIG. 2B illustrates an example session creating node 202 and a corresponding configuration window 204. As an example, the electronic device 110 may receive user's selection of a session creating node, and may add the corresponding session creating node 202 in the canvas component.

As shown in FIG. 2B, the session creating node 202 may be used for triggering creation of a session associated with the workflow. As an example, the electronic device 110 may determine a trigger condition for session creation based on a node to which an input end of the session creating node 202 is connected.

In some embodiments, the electronic device 110 may acquire configuration information about the node via the session creating node 202. As an example, the input of the node may include a session identifier (e.g., a name) of the session to be created. As an example, the electronic device 110 may provide a control 206 for configuring the session identifier in the configuration window 204.

For example, the electronic device 110 may receive a session identifier inputted by the user via the control 206; or the electronic device 110 may support reference to other variables via the control 206. As an example, the user may reference a text variable associated with the workflow or the application to serve as the session identifier of the session to be created.

Additionally, the configuration window 204 may also display a plurality of parameters 208, 210, and 212 that the session creating node 202 is configured to output. For example, the session creating node 202 may output a parameter 208 for whether the session is successfully created, a parameter 210 for whether the session corresponding to the session identifier already exists, and an index parameter 212 of the created session identifier.

For example, if the specified session identifier already exists, the parameter 210 returned by the session creating node 202 may be, for example, True, and the session creating node 202 would not create a corresponding session. Conversely, if the specified session identifier does not exist, the parameter 208 returned by the session creating node 202 may be, for example, True, and the session creating node 202 may output the index parameter 212 of the created session.

In this manner, embodiments of the present disclosure may support developers in dynamically creating new sessions during workflow execution and optionally configuring an identifier, e.g., a name, of the created session.

In some embodiments, the session processing node that the user is allowed to add may further include, for example, a session deleting node. As an example, the session deleting node may be used for deleting a session corresponding to the specified session identifier. As an example, the electronic device 110 may determine the trigger condition for deleting the corresponding session based on the node connected to the input end of the session deleting node.

In some embodiments, the session processing node may further include a context managing node for managing context information of an existing session. As an example, the context managing node may include a context information acquiring node for acquiring context information of a specified session. Alternatively, the context managing node may further include a context information deleting node for deleting the context information of the specified session.

Similarly, the electronic device 110 may determine, based on a node connected to an input end of the context information acquiring node or the context information deleting node, a trigger condition for acquiring or clearing the context information.

As an example, the electronic device 110 may acquire configuration information related to the context information acquiring node. The configuration information may, for example, indicate a session identifier of a session to be acquired, and the context information acquiring node may, for example, output context information of a session corresponding to the session identifier.

FIG. 2C illustrates an example context information deleting node 214 and a corresponding configuration window 216. As an example, the electronic device 110 may receive a user's selection of the context information deleting node, and may add the corresponding context information deleting node 214 in the canvas component.

As shown, the configuration window 216 may include a control 218 for inputting a session identifier. In some embodiments, the control 218 may, for example, support selecting a first session identifier of a first session to be processed from identifiers of a set of sessions associated with workflows or sessions.

Additionally, the configuration window 216 may also display an output parameter 220 of the context information deleting node 214. For example, when the context information deleting node 214 is triggered to execute, deletion of the context information of the corresponding conversation may be triggered. If the context information is successfully deleted, the parameter 220 outputted by the context information deleting node 214 may be, for example, “True”.

In some embodiments, the session processing node may also include a message managing node for managing a session message in the specified session.

In some examples, the message managing node may include a message creating node for creating a new message in the specified session. As another example, the message managing node may include a message modifying node for modifying a message in the specified session.

As yet another example, the message managing node may include a message deleting node for deleting a message in the specified session. Additionally or alternatively, the message managing node may also include a message viewing node for viewing of at least one message in the specified session.

In some embodiments, the electronic device 110 may further acquire, via a configuration window for the message managing node, at least one condition for determining a session message to be managed. As an example, such condition may indicate a time range, a message identifier, or the like of a message to be modified or deleted.

In some embodiments, the configuration information for the message creating node may also indicate, for example, the content of the message to be created. Alternatively or additionally, the configuration information for the message modifying node may indicate the message to be modified and the modified message content. In addition, the configuration information for the message deleting node may indicate at least one condition associated with the message to be deleted.

FIG. 2D illustrates an example message viewing node 222 and a corresponding configuration window 224. As an example, the electronic device 110 may receive a user selection of the message viewing node, and may add the corresponding message viewing node 222 in the canvas component.

As shown, the configuration window 224 may provide a control 226 for configuring a session identifier specified to be managed. Additionally, the configuration window 224 may further provide one or more controls, e.g., a control 228, a control 230, and a control 232, for configuring a condition corresponding to a message to be viewed.

As an example, the control 228 may be used for configuring a number of conversation rounds corresponding to the message to be viewed. The control 230 may be used for configuring return of messages before a specific conversation round. The control 232 may be used for configuring return of messages after a specific conversation round.

In addition, the configuration window 224 may further display an output parameter 234 of the message viewing node 222, which may include, for example, a message list, which may include one or more message objects. Each message object may include an identifier of the message, a role corresponding to the message, a content type of the message, and specific content of the message.

In addition, the output parameter 234 may further include an identifier of the returned first message and an identifier of the returned last message, and a parameter (hasMore) indicating whether some messages are folded.

Based on the approaches described above, in embodiments of the present disclosure, various types of session processing nodes described above may be added, based on the received edit operation, to the node connection graph shown in FIG. 2A, and the configuration information for the session processing nodes may be correspondingly acquired.

Further, the electronic device 110 may create a target workflow based on the configured node connection graph.

In some embodiments, after completing the editing of the node connection graph, the electronic device 110 may, for example, create and publish a corresponding target workflow in response to triggering of the publishing control.

As an example, the electronic device 110 may create a corresponding target workflow based on configuration information for each node in the node connection graph and connections between the nodes. Such target workflow may be published or shared to other users, for example.

In some embodiments, such target workflow may be published independently, or may trigger creation and/or publication of an application associated with the target workflow, e.g., bot or agent. Additionally, such application may for example have a corresponding graphical interface, which is editable via the provided edit interface.

In some embodiments, in addition to the approach of creating or managing the workflow through nodes as described above, the electronic device 110 may, for example, automatically create a second session corresponding to the target workflow when receiving a creation request associated with the target workflow. A second session identifier of the second session is determined based on identifier information of the target workflow.

In some scenarios, the electronic device 110 may, for example, support the user in creating a particular type of workflow, e.g., a session flow. The session flow may support the user in configuring a node corresponding to a session scenario. Accordingly, in creating the session flow, the electronic device 110 may automatically create a corresponding session based on the name of the session flow.

In addition, the electronic device 110 may further provide, for example, a creation entry associated with the application or the workflow. A session created via such creation entry may be referred to as a static session. For example, the electronic device 110 may support the user in creating a static session associated with the application or the workflow by clicking the creation entry. As an example, such static session may be understood, for example, as a global variable associated with the application or the workflow, which supports managing the session based on a session identifier of the static session.

In some embodiments, the session identifier of the created static session may be determined automatically based on a preconfigured rule, or may be determined based on input information of the user.

FIG. 2E further illustrates a session management window 200E according to some embodiments of the present disclosure. The electronic device 110 may, for example, provide the session management window 200E, as shown in the drawings, for the application or the workflow to improve efficiency of session management.

As shown in FIG. 2E, the electronic device 110 may present a plurality of sessions associated with the target workflow in the session management window 200E. As an example, the session management window 200E may present sessions associated with the application including a default session and sessions 1 to 5.

In some embodiments, the electronic device 110 may present a plurality of session lists, e.g., a session list 236 and a session list 240, in the session management window 200E. As an example, the session list 236 may include a static session created via the preconfigured creation entry as described above and/or sessions automatically created by creating a session flow, e.g., the default session and the sessions 1 to 3. The session list 240 may include dynamic sessions created during execution of the workflow, e.g., the sessions 4 to 5.

In some embodiments, the electronic device 110 may further be associated with the session list 236 to provide a creation entry (e.g., a “+” button) for creating a session associated with the workflow or the application.

In addition, the electronic device 110 may further receive a selection of a specific session presented. For example, the electronic device 110 may have received a user's click on a session 238 (e.g., the session 3) and may show one or more session messages in the session 238 correspondingly.

Additionally, the electronic device 110 may, for example, further support the session shown in the user deletion interface 200E. For example, the electronic device 110 may support the user in deleting the static session presented in the session list 236 (e.g., the default session cannot be deleted). For example, when the user long presses “session 2,” the electronic device 110 may show a deletion control for deleting “session 2.”.

FIG. 2F further illustrates an example debug window 200F according to some embodiments of the present disclosure. As shown in FIG. 2F, the debug window 200F may include a selection control 244. As an example, the selection control 244 may trigger presentation of a set of sessions associated with the application or the workflow. For example, the user may specify a target session, e.g., “session 2”, to be shown in the debug window 200F via the selection control 244.

As shown in FIG. 2F, when “session 2” is selected, the electronic device 110 may display one or more session messages in “session 2” in a message display area 246 of the debug window.

In some embodiments, as shown in FIG. 2F, the debug window 200F may further include an input control 250, which may be used for receiving an input message of the user, and may trigger sending of the input message in a target session. In some embodiments, such input message may include a variety of suitable types, such as text messages, voice messages, image messages, file messages, link messages, and the like. For example, the user may upload a local file to the target session via the input control 250.

In addition, as shown in FIG. 2F, the debug window 200F may further include a parameter configuration control 248. The electronic device 110 may further configure at least one input parameter of the workflow via the parameter configuration control 248.

As an example, execution of some workflows relies on one or more input parameters. In addition to supporting the user in specifying such input parameter in a conversational interaction manner, the electronic device 110 may, for example, utilize the parameter configuration control 248 to provide controls corresponding to one or more input parameters of the workflow. For example, the user may directly input the input parameter of the workflow through the corresponding control, thereby improving the debugging efficiency of the workflow or the application.

Based on the processes described above, embodiments of the present disclosure can support managing workflow-related sessions in a node-based manner, thereby improving the efficiency of session management.

### Example Processes

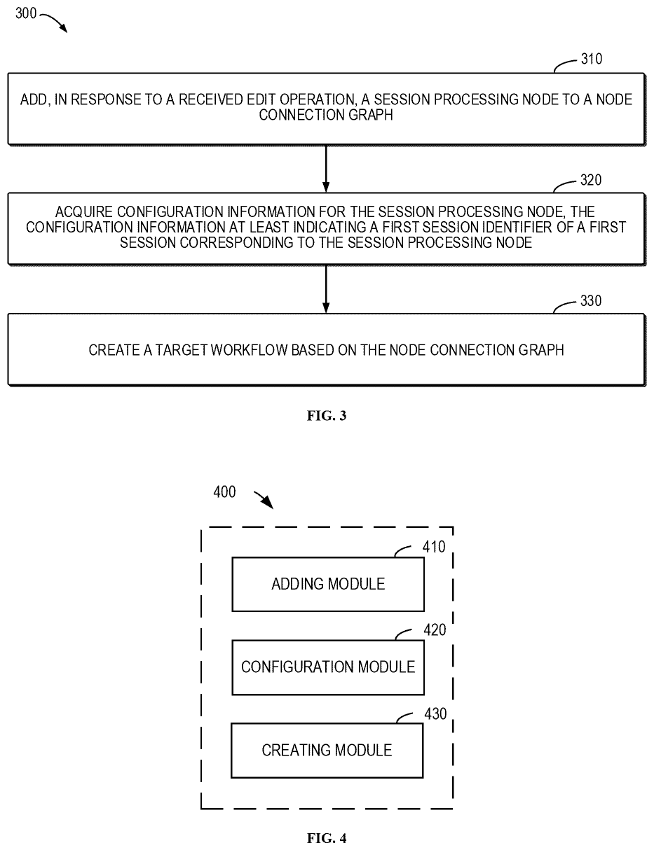

FIG. 3 illustrates a flowchart of a process 300 of creating a workflow according to some embodiments of the present disclosure. The process 300 may be implemented at an electronic device 110. The process 300 is described below with reference to FIG. 1.

As shown in FIG. 3, at block 310, the electronic device 110 adds a session processing node to a node connection graph in response to a received edit operation.

At block 320, the electronic device 110 acquires configuration information for the session processing node. The configuration information at least indicates a first session identifier of a first session corresponding to the session processing node.

At block 330, the electronic device 110 creates a target workflow based on the node connection graph.

In some embodiments, the session processing node includes a session creating node for creating the first session corresponding to the first session identifier.

In some embodiments, the session processing node includes a session deleting node for deleting the first session corresponding to the first session identifier.

In some embodiments, the session processing node includes a context managing node for managing context information of the first session.

In some embodiments, the managing the context information of the first session includes: acquiring the context information of the first session; or deleting the context information of the first session.

In some embodiments, the session processing node includes a message managing node for managing session message in the first session.

In some embodiments, the message managing node includes at least one of: a message creating node for creating a new message in the first session; a message modifying node for modifying a first message in the first session; a message deleting node for deleting a second message in the first session; or a message viewing node for viewing of at least one message in the first session.

In some embodiments, acquiring the configuration information for the session processing node includes: aquring, via a configuration control, at least one condition for determining the session message to be managed.

In some embodiments, the process 300 further includes: in response to receiving a creation request associated with the target workflow, creating a second session corresponding to the target workflow. The second session identifier of the second session is determined based on identifier information of the target workflow.

In some embodiments, the process 300 further includes: providing a first creation entry associated with the target workflow; and in response to a selection of the first creation entry, creating a third session associated with the target workflow.

In some embodiments, a third session identifier of the third session is determined based on the received input information.

In some embodiments, the process 300 further includes: presenting a session management window associated with the target workflow; and presenting, in the session management window, a plurality of sessions associated with the target workflow.

In some embodiments, presenting the plurality of sessions associated with the target workflow in the session management window includes: presenting a first list in the session management window, the first list including a static session created via a preconfigured creation entry; and/or presenting a second list in the session management window, the second list including a dynamic session created during an execution of the target workflow.

In some embodiments, the session management window includes a second creation entry for creating a session associated with the target workflow.

In some embodiments, the process 300 further includes: in response to receiving a first operation for a third session among the plurality of sessions, presenting at least one session message in the third session; or in response to receiving a second operation for a fourth session among the plurality of sessions, deleting the fourth session.

In some embodiments, the process 300 further includes: presenting a debug window for the target workflow, the debug window including a session selection control; and in response to receiving a selection of a target session via the session selection control, presenting a session message in the target session in a message display area of the debug window.

In some embodiments, the debug window further includes an input control, and the method further includes: receiving an input message via the input control; and sending the input message in the target session.

In some embodiments, the debug window further includes a parameter configuration control, and the process 300 further includes: configuring at least one input parameter of the target workflow via the parameter configuration control.

### Example Apparatus and Device

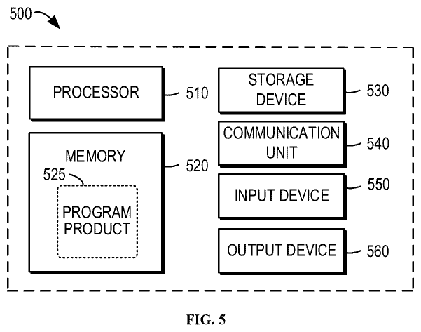

Embodiments of the present disclosure further provide a corresponding apparatus for implementing the above method or process. FIG. 4 illustrates a schematic structural block diagram of an example apparatus 400 for creating a workflow according to some embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes: an adding module 410 configured to add a session processing node to a node connection graph in response to a received edit operation; a configuration module 420 configured to acquire configuration information for the session processing node, the configuration information at least indicating a first session identifier of a first session corresponding to the session processing node; and a creating module 430 configured to create a target workflow based on the node connection graph.

In some embodiments, the session processing node includes a session creating node for creating the first session corresponding to the first session identifier.

In some embodiments, the session processing node includes a session deleting node for deleting the first session corresponding to the first session identifier.

In some embodiments, the session processing node includes a context managing node for managing context information of the first session.

In some embodiments, managing the context information of the first session includes: acquiring the context information of the first session; or deleting the context information of the first session.

In some embodiments, the session processing node includes a message managing node for managing a session message in the first session.

In some embodiments, the message managing node includes at least one of: a message creating node for creating a new message in the first session; a message modifying node for modifying a first message in the first session; a message deleting node for deleting a second message in the first session; or a message viewing node for viewing of at least one message in the first session.

In some embodiments, the configuration module 420 is further configured to acquire, via a configuration control, at least one condition for determining the session message to be managed.

In some embodiments, the apparatus 400 further includes: a second session creating module configured to create, in response to receiving a creation request associated with the target workflow, a second session corresponding to the target workflow. The second session identifier of the second session is determined based on the identifier information of the target workflow.

In some embodiments, the apparatus 400 further includes: a providing module configured to provide a first creation entry associated with the target workflow; and in response to selection of the first creation entry, create a third session associated with the target workflow.

In some embodiments, a third session identifier of the third session is determined based on the received input information.

In some embodiments, the apparatus 400 further includes: a first presentation module configured to present a session management window associated with the target workflow; and present, in the session management window, a plurality of sessions associated with the target workflow.

In some embodiments, the first presentation module is further configured to present a first list in the session management window, the first list including a static session created via a preset creation entry; and/or present a second list in the session management window, the second list including a dynamic session created during an execution of the target workflow.

In some embodiments, the session management window includes a second creation entry for creating a session associated with the target workflow.

In some embodiments, the apparatus 400 further includes: a second presenting module configured to present, in response to receiving a first operation for a third session among the plurality of sessions, at least one session message in the third session; or delete, in response to receiving a second operation for the fourth session among the plurality of sessions, the fourth session.

In some embodiments, the apparatus 400 further includes: a third presenting module configured to present a debug window for the target workflow, the debug window including a session selection control; and present, in response to receiving a selection of a target session via the session selection control, a session message in the target session in a message display area of the debug window.

In some embodiments, the debug window further includes an input control, and the apparatus 400 further includes: a sending module configured to receive an input message via the input control; and send the input message in the target session.

In some embodiments, the debug window further includes a parameter configuration control, and the apparatus 400 further includes: a parameter configuring module configured to configure at least one input parameter of the target workflow via the parameter configuration control.

FIG. 5 illustrates a block diagram of an electronic device 500 in which one or more embodiments of the present disclosure may be implemented. It should be understood that the electronic device 500 shown in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 enables communication with other electronic devices through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. External devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided. The computer program product is tangibly stored on a non-transitory computer-readable medium and includes computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the drawings show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for creating a workflow, comprising:
adding, in response to a received edit operation, a session processing node to a node connection graph;
acquiring configuration information for the session processing node, the configuration information at least indicating a first session identifier of a first session corresponding to the session processing node; and
creating a target workflow based on the node connection graph.

2. The method of claim 1, wherein the session processing node comprises a session creating node for creating the first session corresponding to the first session identifier.

3. The method of claim 1, wherein the session processing node comprises a session deleting node for deleting the first session corresponding to the first session identifier.

4. The method of claim 1, wherein the session processing node comprises a context managing node for managing context information of the first session.

5. The method of claim 4, wherein managing the context information of the first session comprises:
acquiring the context information of the first session; or
deleting the context information of the first session.

6. The method of claim 1, wherein the session processing node comprises a message managing node for managing a session message in the first session.

7. The method of claim 6, wherein the message managing node comprises at least one of:
a message creating node for creating a new message in the first session;
a message modifying node for modifying a first message in the first session;
a message deleting node for deleting a second message in the first session; or a message viewing node for viewing of at least one message in the first session.

8. The method of claim 6, wherein acquiring the configuration information for the session processing node comprises:
acquiring, via a configuration control, at least one condition for determining the session message to be managed.

9. The method of claim 1, further comprising:
creating, in response to receiving a creation request associated with the target workflow, a second session corresponding to the target workflow, a second session identifier of the second session determined based on identifier information of the target workflow.

10. The method of claim 1, further comprising:
providing a first creation entry associated with the target workflow; and
creating, in response to a selection of the first creation entry, a third session associated with the target workflow.

11. The method of claim 10, wherein a third session identifier of the third session is determined based on received input information.

12. The method of claim 1, further comprising:
presenting a session management window associated with the target workflow; and
presenting, in the session management window, a plurality of sessions associated with the target workflow.

13. The method of claim 12, wherein presenting, in the session management window, the plurality of sessions associated with the target workflow comprises at least one of:
presenting a first list in the session management window, the first list comprising a static session created via a preconfigured creation entry; or
presenting a second list in the session management window, the second list comprising a dynamic session created during an execution of the target workflow.

14. The method of claim 12, wherein the session management window comprises a second creation entry for creating a session associated with the target workflow.

15. The method of claim 12, further comprising:
presenting, in response to receiving a first operation for a third session among the plurality of sessions, at least one session message in the third session; or
deleting, in response to receiving a second operation for a fourth session among the plurality of sessions, the fourth session.

16. The method of claim 1, further comprising:
presenting a debug window for the target workflow, the debug window comprising a session selection control; and
presenting, in response to receiving a selection of a target session via the session selection control, a session message in the target session in a message display area of the debug window.

17. The method of claim 16, wherein the debug window further comprises an input control, and the method further comprises:
receiving an input message via the input control; and
sending the input message in the target session.

18. The method of claim 16, wherein the debug window further comprises a parameter configuration control, and the method further comprises:
configuring, via the parameter configuration control, at least one input parameter of the target workflow.

19. An electronic device, comprising:
at least one processor; and
at least one memory coupled to the at least one processor and storing instructions for execution by the at least one processor, the instructions, when executed by the at least one processor, causing the electronic device to perform operations comprising:
adding, in response to a received edit operation, a session processing node to a node connection graph;
acquiring configuration information for the session processing node, the configuration information at least indicating a first session identifier of a first session corresponding to the session processing node; and
creating a target workflow based on the node connection graph.

20. A non-transitory computer-readable storage medium having stored thereon a computer program executable by a processor to perform operations comprising:
adding, in response to a received edit operation, a session processing node to a node connection graph;
acquiring configuration information for the session processing node, the configuration information at least indicating a first session identifier of a first session corresponding to the session processing node; and
creating a target workflow based on the node connection graph.
